(19) United States
(12) Patent Application Publication
(10) Pub. No.: US 2025/0389980 A1
(43) Pub. Date: Dec. 25, 2025

(54) Electro-Optically Tunable Metasurfaces with High Quality Factors

(71) Applicant: California Institute of Technology, Pasadena, CA (US)

(72) Inventors: Ruzan Sokhoyan, Pasadena, CA (US); Harry A. Atwater, South Pasadena, CA (US)

(73) Assignee: California Institute of Technology, Pasadena, CA (US)

(21) Appl. No.: 19/239,785

(22) Filed: Jun. 16, 2025

Related U.S. Application Data
(60) Provisional application No. 63/663,527, filed on Jun. 24, 2024.

(51) Int. Cl. G02F 1/03; G02B 1/00

(52) U.S. Cl. CPC G02F 1/0311; G02B 1/002; G02F 1/0316; G02F 2202/30; G02F 2203/15

(57) ABSTRACT

Systems and methods for high quality factor electro-optically tunable metasurfaces are described. The metasurfaces operate in transmission and/or reflection mode. The metasurfaces can be used for wavefront shaping and beam steering.

### CROSS-REFERENCE TO RELATED APPLICATIONS

The current application claims the benefit of and priority under 35 U.S.C. § 119 (e) to U.S. Provisional Patent Application No. 63/663,527 entitled “High Quality Factor Electro-Optically Tunable Metasurfaces For Active Wavefront Manipulation” filed Jun. 24, 2024. The disclosure of U.S. Provisional Patent Application No. 63/663,527 is hereby incorporated by reference in its entirety for all purposes.

### FIELD OF THE INVENTION

The present invention generally relates to systems and methods for high quality factor metasurfaces for two-dimensional wavefront manipulation.

### BACKGROUND OF THE INVENTION

The regulation of electromagnetic waves with traditional optical components, such as lenses and prisms, is realized through the accumulation of phase delay in the process of light propagation, which limits the reduction and integration of optical devices. Control of phase and amplitude play an important part in wavefront modulation. Traditional optical elements, as well as diffractive elements such as gratings and holograms, can be bulky for optical set-up. Metasurface can modify the amplitude and impart an abrupt phase shift to the incident wave within the sub-wavelength scale through the light-matter interaction and thus realize the wavefront modulation more efficiently.

In optical metasurfaces, a subwavelength-spaced array of localized resonators can be used to abruptly manipulate the phase, amplitude, polarization, and spectrum of light at an interface. Attaining strong light matter interaction and hence high quality factors in metasurfaces can be desirable. However, the required subwavelength scale wavefront control imposes a limit on the resonator size, leading to significant radiative loss. As a result, most metasurfaces are broadband and rely on dielectric structures with limited light confinement and hence low quality factor (Q-factors less than about 15). Low quality factor means photon residence times are very short, and hence local electromagnetic fields tend to be small.

Active metasurfaces can dynamically control the wavefront of the scattered light at a subwavelength scale. Most active metasurfaces that enable dynamic wavefront shaping operate in reflection. Active metasurfaces operating in transmission are of considerable interest as they can be integrated with chip-scale light sources, yielding compact wavefront shaping devices. It is challenging to achieve dynamically tunable metasurfaces with high quality factors.

### BRIEF SUMMARY OF THE INVENTION

Many embodiments are directed to systems of low-loss active metasurfaces that can dynamically manipulate the transmitted light wavefront. In several embodiments, the dynamically tunable metasurfaces can be made with dielectric materials with quality factor of at least 50. In some embodiments, the metasurfaces manipulate the light in transmission mode. In some embodiments, the metasurfaces manipulate the light in reflection mode. The dynamically tunable metasurfaces can manipulate light in various wavelength ranges from ultraviolet to visible to near infrared to infrared wavelengths.

Some embodiments include a metasurface comprising: a plurality of repeating unit cells with a periodicity conformally disposed on a substrate; wherein the periodicity is less than a wavelength in free space of an operating light; wherein each of the plurality of repeating unit cells comprises: a resonant structure on a substrate; an electro-optic layer between the resonant structure and the substrate; and two electrodes configured to apply a bias across the electro-optic layer; wherein the bias changes a refractive index of the electro-optic layer to tune an optical response of the metasurface; and wherein the metasurface controls a phase of the operating light with a quality factor of at least 10.

In some embodiments, the wavelength is selected from the group consisting of: an ultraviolet wavelength from 100 nm to 400 nm, a visible wavelength from 380 nm to 800 nm, a near infrared wavelength from 800 nm to 2500 nm, and an infrared wavelength from 780 nm to 1000 μm.

In some embodiments, the plurality of repeating unit cells is arranged in an array.

In some embodiments, the resonant structure has a shape selected from the group consisting of: a cuboid, a cube, a pillar, a cylinder, an elliptical cylinder, a trapezoid, a triangular prism, a polygonal prism, a pyramid, and a combination thereof.

In some embodiments, the resonant structure has a refractive index greater than the substrate.

In some embodiments, the electro-optic layer has a refractive index less than the substrate.

In some embodiments, the resonant structure comprises a material selected from the group consisting of: gallium arsenide, gallium phosphide, silicon, amorphous silicon, germanium, aluminum arsenide, aluminum gallium arsenide, and molybdenum diselenide.

In some embodiments, the electro-optic layer comprises a material selected from the group consisting of: barium titanate, lithium niobate, JRD1, and polymethyl methacrylate with JRD1.

In some embodiments, the two electrodes are configured to apply a bias across the electro-optic layer laterally or vertically.

In some embodiments, the two electrodes comprise a material selected from the group consisting of: a metal, a doped semiconductor, and graphene.

In some embodiments, the two electrodes comprise a material selected from the group consisting of: gold, silver, copper, aluminum, indium tin oxide, cadmium oxide, aluminum doped zinc oxide, gallium doped zinc oxide, doped gallium arsenide, doped indium arsenide, and doped molybdenum diselenide.

In some embodiments, the electro-optic layer has a shape that overlaps with the resonant structure of each of the repeating unit cells.

In some embodiments, the electro-optic layer has a shape that overlaps with a row of resonant structures.

Some embodiments further comprise a dielectric layer between the resonant structure and the electro-optic layer to avoid electrostatic breakdown.

Some embodiments further comprise a back reflector on an opposite side of the substrate from the resonant structure.

In some embodiments, the back reflector comprises a material selected from the group consisting of: gold, silver, aluminum, copper, a distributed Bragg reflector, and a metasurface mirror.

In some embodiments, a transmittance of the metasurface is greater than 10%.

In some embodiments, a phase shift of the metasurface is from 0 degree to 360 degrees.

In some embodiments, the electro-optic layer comprises lithium niobate, has a thickness between 180 nm and 300 nm, and has a width between 1150 nm and 1400 nm; wherein a period of the plurality of the unit cells in x-direction is 1500 nm and in y-direction is 1440 nm.

In some embodiments, the metasurface is configured to be a portion of: a wavefront shaping system, a dynamic beam steering system or a chip scale laser.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention. It should be noted that the patent or application file contains at least one drawing executed in color. Copies of this patent or patent application publication with color drawing(s) will be provided by the Office upon request and payment of the necessary fee.

FIGS. 1A and 1B illustrate a metasurface configuration in accordance with an embodiment of the invention.

FIGS. 2A and 2B illustrate a metasurface configuration in accordance with an embodiment of the invention.

FIGS. 3A and 3B illustrate a metasurface configuration in accordance with an embodiment of the invention.

FIGS. 3C through 3E illustrate the metasurface transmittance, phase, and phase shift in accordance with an embodiment of the invention.

FIGS. 4A and 4B illustrate a metasurface configuration in accordance with an embodiment of the invention.

FIG. 5 illustrates a metasurface configuration in accordance with an embodiment of the invention.

FIGS. 6A and 6B illustrate a metasurface configuration in accordance with an embodiment of the invention.

FIGS. 6C and 6D illustrate the metasurface reflectance and phase shift in accordance with an embodiment of the invention.

FIGS. 7A through 7E illustrate the effect of changing the resonator height on transmittance and phase in accordance with an embodiment of the invention.

FIGS. 8A through 8D illustrate the effect of changing the resonator height on transmittance and phase in accordance with an embodiment of the invention.

FIGS. 9A through 9C illustrate the effect of changing the electro-optic layer thickness on transmittance and phase in accordance with an embodiment of the invention.

FIGS. 10A through 10E illustrate the effect of changing the electro-optic layer thickness on transmittance and phase in accordance with an embodiment of the invention.

FIGS. 11A through 11D illustrate the effect of changing the electro-optic layer thickness on transmittance and phase in accordance with an embodiment of the invention.

FIGS. 12A through 12I illustrate the effect of changing the electro-optic layer thickness on transmittance and phase in accordance with an embodiment of the invention.

FIGS. 13A through 13F illustrate the effect of changing the electro-optic layer thickness on transmittance and phase in accordance with an embodiment of the invention.

FIGS. 14A through 14F illustrate the effect of changing the electro-optic layer thickness on transmittance and phase in accordance with an embodiment of the invention.

FIGS. 15A through 15F illustrate the effect of changing the period in the x-direction on transmittance and phase in accordance with an embodiment of the invention.

FIGS. 16A through 16D illustrate the transmittance and phase change with varying refractive index in accordance with an embodiment of the invention.

FIGS. 17A through 17J illustrate the effect of changing the electro-optic layer thickness on transmittance and phase in accordance with an embodiment of the invention.

FIGS. 18A through 18F illustrate the effect of changing the electro-optic layer width on transmittance and phase in accordance with an embodiment of the invention.

FIGS. 19A through 19E illustrate the effect of changing the electro-optic layer width on transmittance and phase in accordance with an embodiment of the invention.

FIGS. 20A through 20C illustrate the effect of changing the electro-optic layer refractive index on transmittance and phase in accordance with an embodiment of the invention.

### DETAILED DESCRIPTION OF THE INVENTION

Many embodiments provide dielectric high quality factor (Q or Q factor) metasurface structures in transmission mode and/or in reflection mode. The high Q metasurfaces can control the wavefront of light passively or actively. Several embodiments use high Q subwavelength resonators on top of electro-optic materials as metasurface building blocks such that the metasurface can achieve dynamically tunable optical response upon modulation of the external stimulus. The metasurfaces can be used for (but not limited to) reconfigurable beam steering devices, dynamic holograms, tunable ultrathin lenses, nanoprojectors, nanoscale spatial light modulators, and/or free space optical communications. Many embodiments implement interconnect architectures to enable dynamic beam steering via electric-optic modulation. Some embodiments integrate the metasurfaces with chip-scale lasers and/or light sources.

In many embodiments, the transmissive active metasurfaces operate at near infrared wavelengths (from about 800 nm to about 2500 nm). The transmissive active metasurfaces in accordance with some embodiments can be excited by a normally incident linearly polarized light, exploiting from lower-Q modes to high-Q modes. In various embodiments, the metasurfaces can achieve quality factor of at least about 10; or at least about 20; or at least about 30; or at least about 40; or at least about 50; or at least about 60; or at least about 70; or at least about 80; or at least about 90; or at least about 100; or at least about 200; or at least about 300; or at least about 400; or at least about 500; or at least about 600; or at least about 700; or at least about 800; or at least about 900; or at least about 1000; or at least about 2000; or at least about 3000; or at least about 4000; or at least about 5000; or at least about 6000; or at least about 7000; or at least about 8000; or at least about 9000; or less than or equal to about 10000; or from about 100 to about 999; or from about 1000 to about 10000; or from about 1000 to about 9999; or from about 3000 to about 9800. In various embodiments, lower-Q or low-Q refers to quality factor from about 100 to about 999. In certain embodiments, higher-Q or high-Q refers to quality factor from about 1000 to about 10000.

The metasurfaces in accordance with many embodiments can manipulate the wavefront of light of various wavelengths with high quality factors. The light can have wavelengths including (but not limited to) ultraviolet wavelengths from about 100 nm to about 400 nm; visible wavelengths from about 380 nm to about 800 nm; near infrared wavelengths from about 800 nm to about 2500 nm; infrared wavelengths from about 780 nm to about 1000 μm. The light being manipulated by the metasurfaces can have a single wavelength or a range of wavelengths such as broadband illumination. In order to manipulate different wavelengths of incoming light, the metasurfaces can be made of various shapes, and/or various materials. In certain embodiments, the desired dimensions and/or materials of the nanostructures on the substrates can be selected for the light wavelength(s). The metasurfaces can be designed to exhibit multiple high quality optical resonances that appear at different wavelengths and show selective wavefront manipulation capabilities at different wavelengths.

A building block of the metasurfaces in accordance with various embodiments includes a high Q subwavelength resonator on top of an electro-optic material. In several embodiments, the high Q resonator can have dimensions equal to or greater than the wavelength of the operating light. The high Q resonator has a thickness greater than the thickness of the electro-optic material. The high Q resonator has a higher refractive index than the electro-optic material. The high-index resonator supports the high Q modes. The high Q modes can partially penetrate the lower index electro-optic materials. A bias (such as a direct current electric field) can be applied across the electro-optic material to change and/or control the refractive index of the electro-optic material. The change of refractive index of the electro-optic material can tune the optical response of the metasurfaces.

Several embodiments implement interconnected architectures to dynamically control the optical response of the metasurface. In some embodiments, electrodes can be integrated into the electro-optic material. In some embodiments, the electrodes can be on the sides of the electro-optic material such that the bias can be applied laterally (such as in x-direction). In some embodiments, the electrodes can be on top of the electro-optic material such that the bias can be applied vertically (such as in z-direction).

In several embodiments, a plurality of the high-index resonators (also referred as resonant structures) can be formed on a substrate with space between each of the plurality of the high-index resonators. The resonators on the substrates can be made of various structures and/or dimensions. The resonators on the substrates can be arranged in an array; or in parallel lines; or in straight lines; or in curved lines; or in an aperiodic manner. In several embodiments, the resonator can have a symmetrical shape. In some embodiments, the resonator can have a non-symmetrical shape to induce a polarization selective response or a chiral response. The resonator can have various shapes such as (but not limited to) parallelepiped shapes, cuboids, cubes, pillars, cylinders, elliptical cylinders, trapezoids, triangular prisms, polygonal prisms, pyramids, and any combinations thereof. As can readily be appreciated, any of a variety of shapes of the resonator can be utilized as appropriate to the requirements of specific applications in accordance with various embodiments of the invention. The geometrical dimensions of the resonator, such as length L, width W, or height H, can vary arbitrarily in a non-uniform manner over the aperture of the metasurface device according to the optical function of the metasurface. The resonator and the substrate can be made with high refractive index materials with a large nonlinear optical susceptibility to enhance nonlinear optical parametric conversion processes and/or lossless dielectric materials. The lossless dielectric materials can have an imaginary refractive index (also known as extinction coefficient) of less than or equal to about 0.5; or less than or equal to about 0.1; or less than or equal to about 0.05 at the wavelength of operation. The refractive index of the resonator is higher than the refractive index of the substrate. Examples of high refractive index materials include (but are not limited to) gallium arsenide, gallium phosphide, silicon, amorphous silicon, crystalline silicon, silicon oxide, silicon carbide, germanium, titanium oxide, silicon nitride, aluminum arsenide, aluminum gallium arsenide, and molybdenum diselenide. As can readily be appreciated, any of a variety of materials can be utilized as appropriate to the requirements of specific applications in accordance with various embodiments of the invention.

Several embodiments identify a high-Q resonance supported by the metasurface by determining the reflectance and transmittance as a function of wavelength. Some embodiments implement the high-index resonator in the shape of a pillar and change its dimensions. When considering a silicon pillar on the SiO₂ substrate, the highest Q can be achieved at the pillar height of about 860 nm. (See, e.g., U.S. application Ser. No. 18/435,889 filed Feb. 7, 2024, the disclosure of which is herein incorporated by reference in its entirety.)

Many embodiments integrate an electro-optic material into the metasurface structure. In some embodiments, the electro-optic material can be deposited between the resonator and the substrate. In some embodiments, the electro-optic material layer can have a shape that overlaps with each of the plurality of the high-index resonators. In some embodiments, the electro-optic material can have an elongated shape that overlaps with a row of the high-index resonators. The electro-optic material layer has a thickness that is less than the thickness of the high-index resonator. In certain embodiments, the electro-optic material layer has a thickness that is greater than or equal to the thickness of the high-index resonator. In several embodiments, a bias can be applied across the electro-optic material to change the refractive index. The bias is applied across the electro-optic material instead of the high-index resonator such that the electric field does not interfere with the optic field of the high-index resonator. In certain embodiments, the electro-optic material has a refractive index less than the refractive index of the substrate. Examples of electro-optic materials include (but are not limited to) barium titanate (BTO), lithium niobate (LNO), aluminum nitride, organic electro-optic polymer, chromophore JRD1. As can readily be appreciated, any of a variety of materials can be utilized as appropriate to the requirements of specific applications in accordance with various embodiments of the invention.

In some embodiments, the metasurfaces may not include the substrate. In other words, the electro-optic material can operate as a substrate. The metasurfaces comprise the electro-optic material with the high Q resonators on top. In this implementation, lateral electrodes can be placed on top of the electro-optic material.

In several embodiments, electrodes can be integrated with the electro-optic materials to apply a bias. The electrodes can be formed on the sides of the electro-optic material layer so the bias can be applied laterally. The electrodes can be formed on top of the electro-optic material layer so the bias can be applied vertically. The electrodes can be formed on the sides of the electro-optic material, but with a distance from the electro-optic material. In such embodiments, the bias is applied laterally, but the electrodes do not touch the electro-optic material. When applying the bias, part of the electric field can go through air and then penetrate into the electro-optic material. The electrodes can be formed on the sides of the electro-optic material with a non-electro-optic material sandwiched between the electrodes and the electro-optic material. The electrodes can be made of electrically conductive materials including (but not limited to) metals (such as, gold (Au), silver (Ag), copper (Cu)) and doped semiconductors (such as, indium tin oxide, cadmium oxide, silicon, gallium arsenide, indium arsenide, molybdenum diselenide).

A repeating unit (referred to as a unit cell) of the metasurface can include the resonators and the corresponding electro-optic layer and electrodes. A unit cell can include at least one resonator and the corresponding electro-optic layer and electrodes; or at least two resonators and their corresponding electro-optic layer and electrodes; or at least three resonators and their corresponding electro-optic layer and electrodes; or at least four resonators and their corresponding electro-optic layer and electrodes; or at least five resonators and their corresponding electro-optic layer and electrodes. The repeating unit cells can have a periodicity P. The resonator has dimensions including a length L, a width W, and a height H. In several embodiments, the periodicity P of the metasurfaces is less than the wavelength of the light. In various embodiments, the periodicity P of the metasurfaces can be greater than or equal to the wavelength of the light. In some embodiments, the length L, the width W, and the height H of the resonator are less than the periodicity P. The length L, the width W, and the height H of the resonator can be the same or can be different. In various embodiments, the length L, the width W, and the height H scale linearly with the operating wavelength of the light. In many embodiments, the metasurface structures can include a plurality of unit cells. The unit cells can have various structures and sizes. The resonators and the corresponding electro-optic layer and electrodes can be deposited conformally onto the substrate(s).

In some embodiments, the dimensions of the substrates can have various sizes ranging from microns to millimeters or larger. Examples of one dimension of the substrate include (but are not limited to) greater than or equal to about 1 μm; greater than or equal to about 5 μm; greater than or equal to about 10 μm; greater than or equal to about 50 μm; greater than or equal to about 100 μm; greater than or equal to about 150 μm; greater than or equal to about 200 μm; greater than or equal to about 300 μm; greater than or equal to about 400 μm; greater than or equal to about 500 μm; greater than or equal to about 1 mm; greater than or equal to about 2 mm; greater than or equal to about 3 mm; greater than or equal to about 4 mm; greater than or equal to about 5 mm; greater than or equal to about 10 mm. The layer thickness of the substrate (i.e. in the z direction) can have a thickness ranging from 0.1 nm to several millimeters or larger.

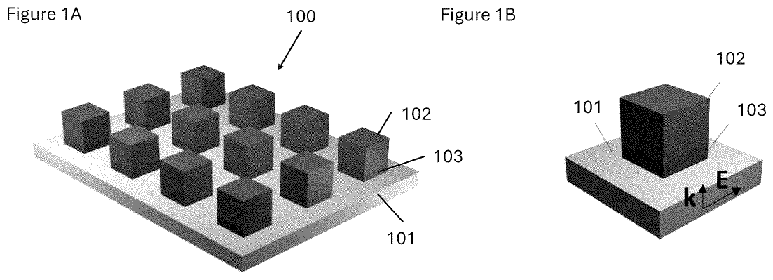

Many embodiments provide various configurations of the metasurface. FIG. 1A illustrates a metasurface configuration in accordance with an embodiment of the invention. FIG. 1B illustrates a unit cell of the metasurface in FIG. 1A in accordance with an embodiment of the invention. The metasurface 100 includes a substrate 101, a high-index resonator 102, and an electro-optic material 103. The metasurface 100 can achieve high Q and can passively or actively control the wavefront of light. The high-index resonators 102 support high Q modes. The high Q modes can be a result of interference of multiple modes supported by the high-index resonators, or higher-order Mie modes supported by the high-index resonator. The mode partially penetrates into the lower index electro-optic material 103. Tunable optical response of the metasurface 100 can be achieved by applying DC bias across the electro-optic material 103. Each of the high-index resonators 102 can have the shape of a parallelepiped. The resonators 102 can be arranged in parallel on a layer of a lower-index electro-optic material 103 on the substrate 101. The refractive index of the electro-optic material can be dynamically controlled upon application of DC electric field across it. The high refractive index resonators 102 can be made of materials including (but not limited to) silicon (Si), germanium (Ge), gallium arsenide (GaAs), gallium phosphide (GaP), and molybdenum diselenide (MoSe₂). The electro-optic material 103 can be lithium niobate (LNO), barium titanate (BTO), organic electro-optic polymer such as JRD1, or JRD1 with polymethyl methacrylate (PMMA). While FIG. 1B shows a parallelepiped-shaped metasurface unit cell, other metasurface unit cell geometries, such as cylinders, or symmetry-broken high Q resonators, are also possible.

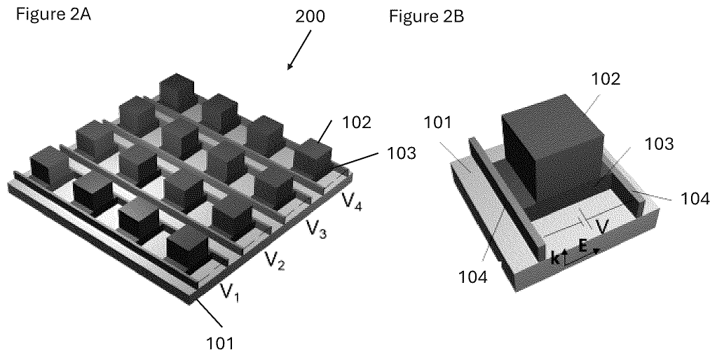

Several embodiments implement inter-connected architectures to dynamically control the optical response of the metasurface. FIG. 2A illustrates a metasurface with electrodes arranged laterally in accordance with an embodiment of the invention. FIG. 2B illustrates a unit cell of the metasurface in FIG. 2A in accordance with an embodiment of the invention. The metasurface 200 includes a substrate 101, a high-index resonator 102, and an electro-optic material 103. The electro-optic material 103 is arranged into patches underneath each of the high-index resonator 102. Electrodes 104 can be arranged laterally (in the x-direction) to apply a bias to the electro-optic material 103. A pair of electrodes 104 can apply bias to a plurality of metasurface unit cells. In FIG. 2A, a pair of electrodes 104 can apply bias to a row of metasurface unit cells. As shown in FIG. 2A, four pairs of electrodes 104 apply bias to four rows of repeating unit cells of the metasurface. The applied four bias can be the same magnitude or different. The electrodes can be made of conductive materials. The electrodes can be made of metal (such as Au, Ag, Cu) or lightly doped semiconductors (such as indium tin oxide (ITO), cadmium oxide (CdO), lightly doped Si, lightly doped GaAs, lightly doped InAs, lightly doped MoSe₂). A thin layer of a dielectric material (not shown) can be deposited on top of the electro-optic material 103 and the electrodes 104 to avoid electrostatic breakdown.

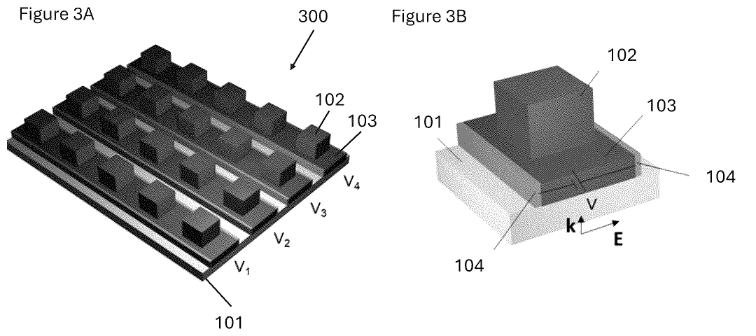

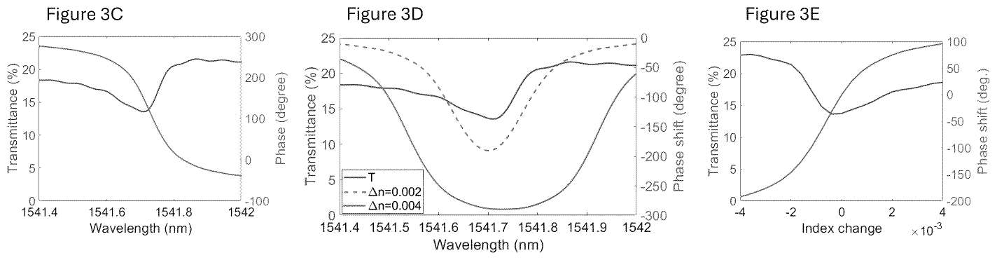

FIG. 3A illustrates a metasurface with electrodes arranged laterally in a different configuration in accordance with an embodiment of the invention. FIG. 3B illustrates a unit cell of the metasurface in FIG. 3A in accordance with an embodiment of the invention. The metasurface 300 includes a substrate 101, a high-index resonator 102, and an electro-optic material 103. The electro-optic material 103 is arranged into stripes underneath a row of the high-index resonator 102. Electrodes 104 can be arranged laterally (in the x-direction) to apply a bias to a stripe of the electro-optic material 103. A pair of electrodes 104 can apply bias to a plurality of metasurface unit cells. In FIG. 2A, four pairs of electrodes 104 apply bias to four stripes of the electro-optic material 103. The applied four bias can be the same magnitude or different. The electrodes can be made of conductive materials. The electrodes can be made of metal (such as Au, Ag, Cu) or lightly doped semiconductors (such as ITO, CdO, lightly doped Si, lightly doped GaAs, lightly doped InAs, lightly doped MoSe₂), or two-dimensional materials, such as graphene. A thin layer of a dielectric material (not shown) can be deposited on top of the electro-optic material 103 and the electrodes 104 to avoid electrostatic breakdown. FIGS. 3C through 3E illustrate the dynamically tunable phase shift of the transmissive metasurface in accordance with an embodiment. FIG. 3C shows transmittance and phase at various wavelengths. FIG. 3D shows phase shift with different refractive index. FIG. 3E shows transmittance and phase shift with varying refractive index. The metasurface can achieve an electrically tunable phase shift of up to about 290 degrees, and the transmittance is greater than about 12% for the applied bias values.

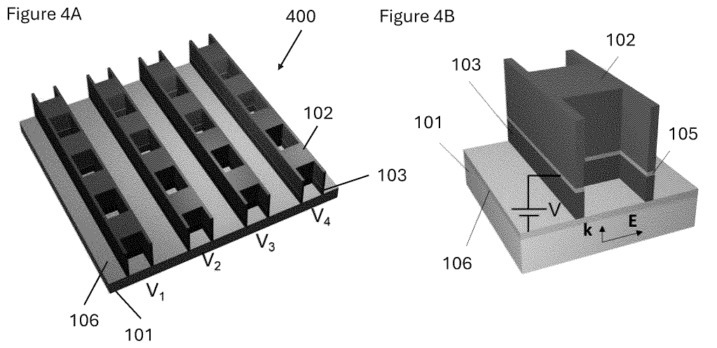

FIG. 4A illustrates a metasurface with electrodes arranged vertically in accordance with an embodiment of the invention. FIG. 4B illustrates a unit cell of the metasurface in FIG. 4A in accordance with an embodiment of the invention. The metasurface 400 includes a substrate 101, a high-index resonator 102, and an electro-optic material 103. Top electrodes 105 and bottom electrodes 106 can be arranged vertically (in the z-direction) to apply a bias to the electro-optic material 103. The bottom electrode 106 can be a layer of electrically conductive material deposited on top of the substrate 101. In certain embodiments, the bottom electrodes 106 can be metal (such as Au, Ag, Cu), or lightly doped semiconductors (such as Si, GaAs, InAs, MoSe₂, ITO, CdO) or graphene. The thickness of the bottom electrodes 106 can range from tens of nanometers to thousands of nanometers. In certain embodiments, the top electrode 105 can be an electrode layer that has a matching shape underneath the electro-optic material. The top electrode 105 can be metal (such as Au, Ag, Cu), doped semiconductor (such as Si, GaAs, InAs, MoSe₂, ITO, CdO), or graphene.

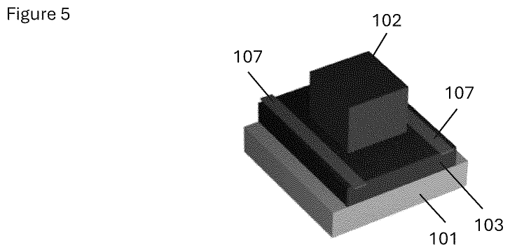

FIG. 5 illustrates a unit cell of a metasurface in accordance with an embodiment of the invention. The unit cell of the metasurface includes a substrate 101, a high-index resonator 102, and an electro-optic material 103. Electrodes 107 can be arranged on top of the electro-optic material 103 such that a bias can be applied laterally across the electro-optic material 103. The electrodes 107 can be electrically conductive material deposited on the electro-optic material 103. The electrodes 107 can be made of metal (Au, Ag, Cu), or lightly doped semiconductors (such as Si, GaAs, InAs, MoSe₂, ITO, CdO). A thin layer of a dielectric material (not shown) can be deposited on top of the electro-optic material 103 and the electrodes 107 to avoid electrostatic breakdown.

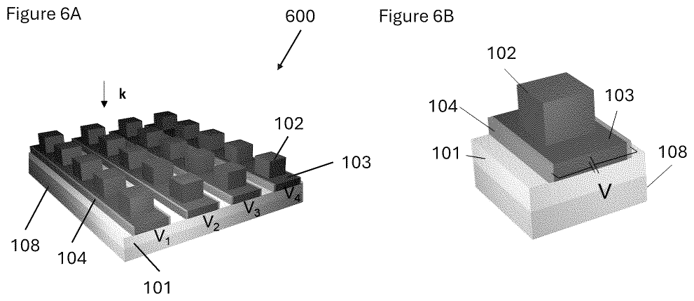

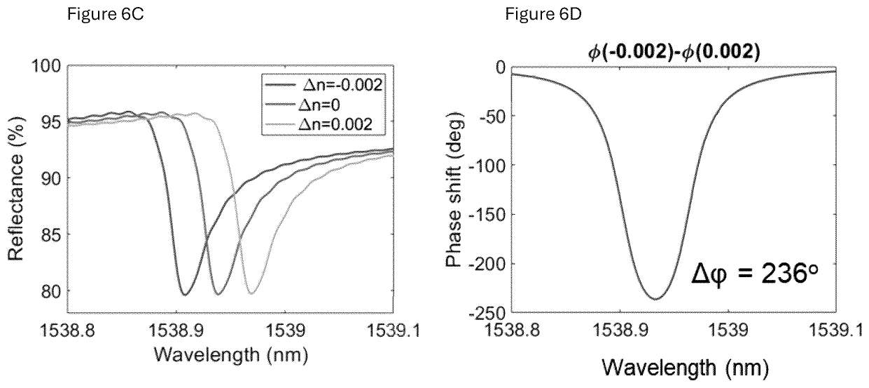

Several embodiments provide a high-reflectance electro-optically tunable high-Q metasurfaces by incorporating a metallic or dielectric mirror. The metallic or dielectric mirror can be incorporated underneath the resonator followed by a low refractive index layer. FIG. 6A illustrates a reflective electro-optically tunable reflective metasurface in accordance with an embodiment of the invention. FIG. 6B illustrates a unit cell of the metasurface in FIG. 6A in accordance with an embodiment of the invention. The metasurface 600 includes a substrate 101, a high-index resonator 102, an electro-optic material 103, laterally arranged electrodes 104, and a reflector layer 108. The back reflector 108 can be a metallic or dielectric mirror such as Au, Ag, aluminum (Al), Cu, distributed Bragg reflector (DBR) mirror or a metasurface mirror. A low-index spacer 101 can be made with silica, alumina, hafnia, PMMA or any other dielectric material. An electro-optic material 103 can be lithium niobate, barium titanate, PMMA with JRD1 molecules, or any other electro-optically tunable material. The electro-optic material 103 can be arranged in stripes as shown or in patches (such as in FIGS. 1A through 2B). The lateral electrodes 104 can be formed as shown or in configurations such as in FIGS. 2A and 2B, or FIGS. 3A and 3B. The electrodes 104 can be made with ITO, CdO, aluminum doped zinc oxide (AZO), gallium doped zinc oxide (GZO), doped Si (or any other doped semiconductor), Au, Ag, Al, Cu, or graphene. The high-index resonator 102 on top of the stripe of the electro-optic material 103 can be made with Si, GaAs, InP, AlGaAs, AlAs, GaP, MoSe₂. FIG. 6C illustrates the reflectance at various wavelengths with varying refractive index. FIG. 6D illustrates the phase shift at various wavelengths. The dynamically tunable metasurfaces have optical efficiencies greater than about 80%.

Many embodiments implement the metasurface to dynamically control and/or tune the wavefront of light. Several embodiments determine the high Q resonance supported by the metasurface by changing the dimensions of the high-index resonator on the substrate. The highest Q factor and the corresponding resonator dimensions can be determined for the chosen resonator and substrate materials. The highest Q can be achieved for a silicon pillar on the silicon oxide substrate when the pillar has a height of about 860 nm. Several embodiments then integrate the electro-optic material into the metasurface structure for dynamic control of the light transmission and/or reflection. For observing strong tunability of the reflected or transmitted light, it is desirable to ensure that the electro-optic material is as thick as possible. The optimal thickness of the electro-optic material can be determined for the selected high-index resonator dimensions and materials, and substrate dimensions and materials. In some embodiments, although the dimensions of the high-index pillars are selected to achieve the highest Q given the high-index resonator materials and substrate, modifications to the selected dimensions are needed to achieve the highest Q after incorporating the electro-optic material. For example, if the pillar dimensions are kept close to the dimensions, ensuring the highest Q in the case of the silicon oxide substrate and silicon pillar configuration, for the electro-optic material thickness of about 180 nm, the desired phase characteristic in transmission is not observed. Several embodiments provide that by reducing the pillar height from its highest-Q-on-SiO₂ value by about 2.5% to about 5%, the desired phase characteristics and tunable behavior in transmission can be observed, when the electro-optic material thickness is greater than about 150 nm.

In many embodiments, the electrically tunable metasurface can achieve performance where the transmission stays greater than about 10% and remains almost constant while the phase varies in the spectral domain from about 0 degrees to about 360 degrees for operating wavelengths. These electrically tunable metasurfaces in accordance with several embodiments incorporate an electro-optic material underneath the high-index resonator. Several embodiments carefully choose the dimensions of various components of the metasurface (such as the dimensions of the electro-optic material, the period of the unit cell) to realize the optimal performance. In some embodiments, the electro-optic material can be in the form of a stripe. In some embodiments, when the electrodes are deposited on top of the electro-optic material, the electro-optic material can be a thin continuous film. In some embodiments, the high-index resonator height should be slightly smaller than the optimal highest-Q height established in the simulations on the low-index substrate. In some embodiments, the electro-optic material can be LNO and the thickness is between about 180 nm and about 300 nm, and the width is between about 1150 nm and about 1400 nm. In some embodiments, the period of the unit cell in the x-direction Px is about 1500 nm, and the period of the unit cell in the y-direction Py is about 1440 nm. As can be readily appreciated, different geometries of the metasurface other than the ones described can also enable the optimal metasurface performance.

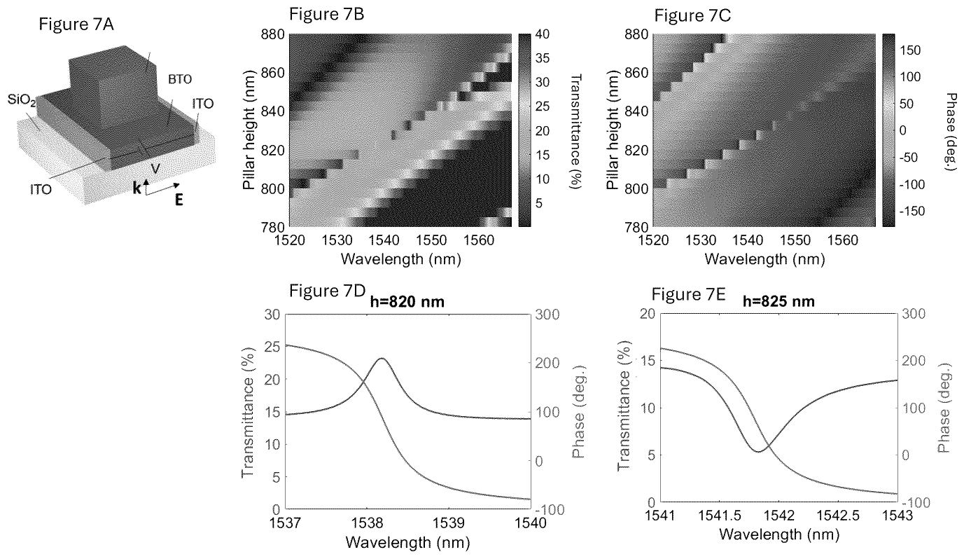

FIGS. 7A through 7E illustrate modifications of metasurface unit cell in accordance with an embodiment. FIG. 7A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of BTO, the electrodes of ITO, and the substrate of silicon oxide. The length of the electro-optic material in the x direction is about 1250 nm. The length of the electro-optic material in the y direction is set to be infinite. The periodicity in the x direction is about 1425 nm and in the y direction is about 1500 nm. The thickness of the electro-optic material is about 180 nm. The width of the electrodes is about 40 nm. FIG. 7B shows the transmittance at various pillar height and various operating wavelengths. FIG. 7C shows the phase at various pillar height at various operating wavelengths. FIG. 7D shows the transmittance and phase at various operating wavelengths when the pillar height is at about 820 nm. FIG. 7E shows the transmittance and phase at various operating wavelengths when the pillar height is at about 825 nm. High Q-factors are accompanied with a dip in the curve. Appropriately choosing the thickness of the electro-optic material enables to achieve an almost flat transmittance.

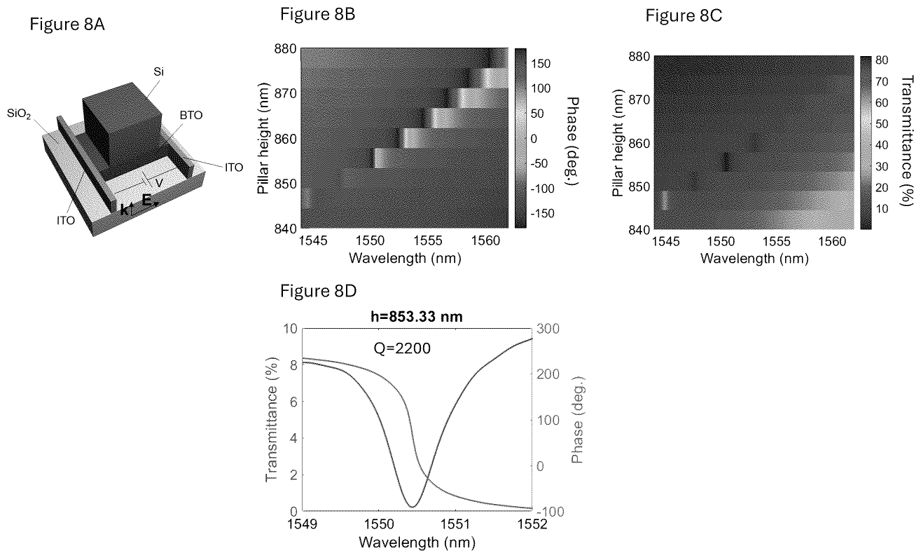

Several embodiments investigate the effect of changing high-index resonator dimensions on Q while maintaining the electro-optic layer at a certain thickness. FIGS. 8A through 8D illustrate modifications of metasurface unit cell in accordance with an embodiment. FIG. 8A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of BTO, the electrodes of ITO, and the substrate of silicon oxide. The length of the electro-optic material in the x direction is about 1200 nm and in the y direction is about 963 nm. The periodicity in the x direction is about 1425 nm and in the y direction is about 1425 nm. The thickness of the electro-optic material is about 200 nm. The width of the electrodes is about 50 nm and height is about 200 nm. The charge carrier density of the ITO electrodes is about 5e19 cm⁻³. FIG. 8B shows the phase at various pillar heights and various operating wavelengths. FIG. 8C shows the transmittance at various pillar height at various operating wavelengths. FIG. 8D shows the transmittance and phase at various operating wavelengths when the pillar height is at about 853 nm. The thickness of the electric-optic layer increases to about 200 nm, and the Q drops to about 2200.

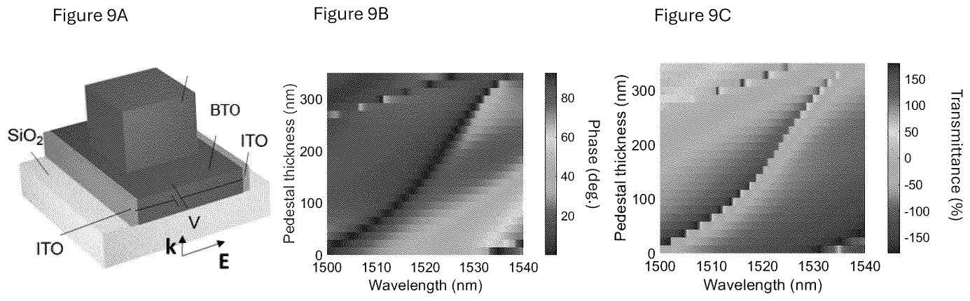

Some embodiments determine the optimal electro-optic layer thickness to achieve high Q at various high-index resonator dimensions. FIGS. 9A through 9C illustrate modifications of metasurface unit cell in accordance with an embodiment. FIG. 9A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of BTO, the electrodes of ITO, and the substrate of silicon oxide. The length of the electro-optic material in the x direction is about 1200 nm and in the y direction is set to be infinite. The periodicity in the x direction is about 1425 nm and in the y direction is about 1425 nm. The high-index resonator has a height of about 800 nm. FIG. 9B shows the phase at various electro-optic layer thickness (shown as pedestal thickness) and various operating wavelengths. FIG. 9C shows the transmittance at various electro-optic layer thickness (shown as pedestal thickness) and various operating wavelengths.

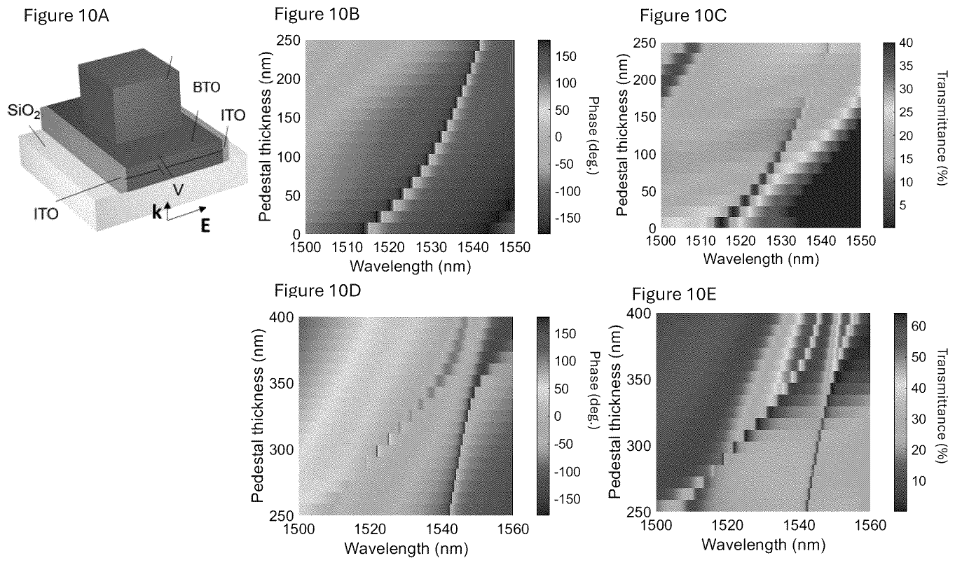

FIGS. 10A through 10E illustrate modifications of metasurface unit cell in accordance with an embodiment. FIG. 10A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of BTO, the electrodes of ITO, and the substrate of silicon oxide. The length of the electro-optic material in the x direction is about 1200 nm and in the y direction is set to be infinite. The periodicity in the x direction is about 1425 nm and in the y direction is about 1425 nm. The high-index resonator has a height of about 820 nm. FIGS. 10B and 10D show the phase at various electro-optic layer thickness (shown as pedestal thickness) and various operating wavelengths. FIGS. 10C and 10E show the transmittance at various electro-optic layer thickness (shown as pedestal thickness) and various operating wavelengths. The thickness in FIGS. 10B and 10C varies from about 0 nm to about 250 nm. The thickness in FIGS. 10D and 10E varies from about 250 nm to about 400 nm.

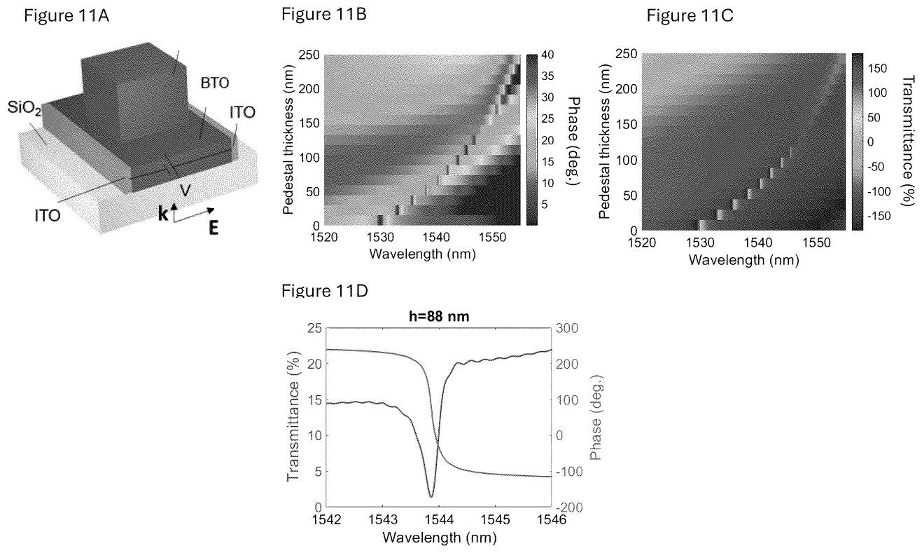

FIGS. 11A through 11D illustrate modifications of metasurface unit cell in accordance with an embodiment. FIG. 11A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of BTO, the electrodes of ITO, and the substrate of silicon oxide. The length of the electro-optic material in the x direction is about 1200 nm and in the y direction is set to be infinite. The periodicity in the x direction is about 1425 nm and in the y direction is about 1425 nm. The high-index resonator has a height of about 840 nm. FIG. 11B shows the phase at various electro-optic layer thickness (shown as pedestal thickness) and various operating wavelengths. FIG. 11C shows the transmittance at various electro-optic layer thickness (shown as pedestal thickness) and various operating wavelengths. FIG. 11D shows transmittance and phase at various wavelengths when the electro-optic layer thickness is about 88 nm.

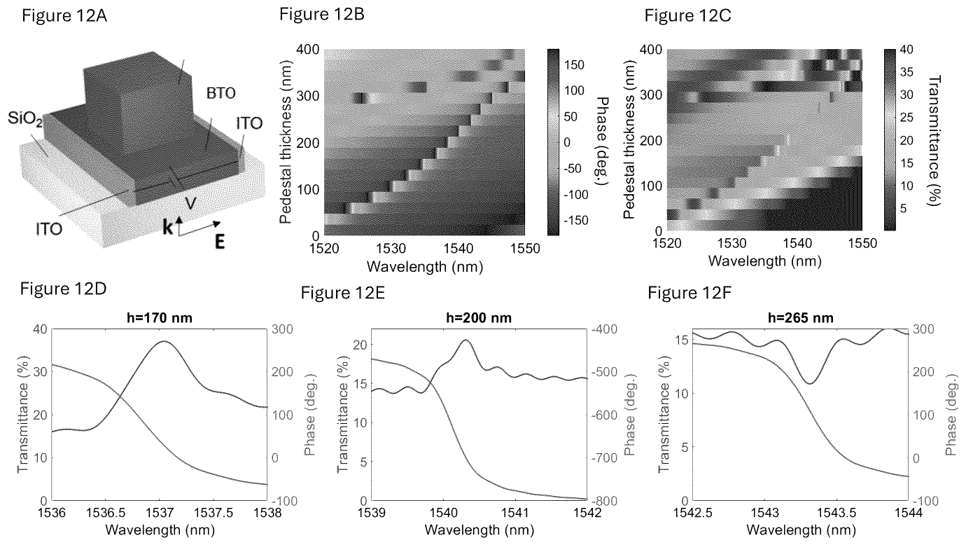

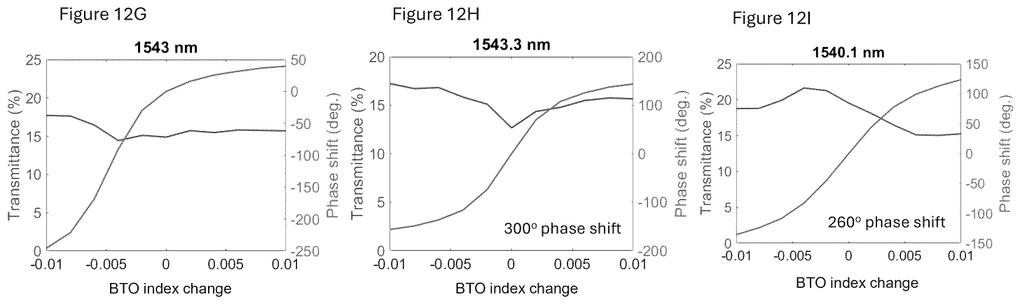

FIGS. 12A through 12I illustrate modifications of metasurface unit cell in accordance with an embodiment. FIG. 12A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of BTO, the electrodes of ITO, and the substrate of silicon oxide. The length of the electro-optic material in the x direction is about 1200 nm and in the y direction is set to be infinite. The periodicity in the x direction is about 1425 nm and in the y direction is about 1425 nm. The high-index resonator has a height of about 820 nm. The ITO electrodes have a width of about 40 nm. FIG. 12B shows the phase at various electro-optic layer thickness (shown as pedestal thickness) and various operating wavelengths. FIG. 12C shows the transmittance at various electro-optic layer thickness (shown as pedestal thickness) and various operating wavelengths. FIG. 12D shows transmittance and phase at various wavelengths when the electro-optic layer thickness is about 170 nm. FIG. 12E shows transmittance and phase at various wavelengths when the electro-optic layer thickness is about 200 nm. FIG. 12F shows transmittance and phase at various wavelengths when the electro-optic layer thickness is about 265 nm. FIG. 12G shows transmittance and phase when the refractive index of BTO changes from −0.01 to 0.01 at 1543 nm wavelength. The electro-optic layer thickness is about 265 nm. FIG. 12H shows transmittance and phase when the refractive index of BTO changes from −0.01 to 0.01 at 1543.3 nm wavelength. The electro-optic layer thickness is about 265 nm. FIG. 12I shows transmittance and phase when the refractive index of Si changes from −0.01 to 0.01 at 1540.1 nm wavelength. The electro-optic layer thickness is about 200 nm.

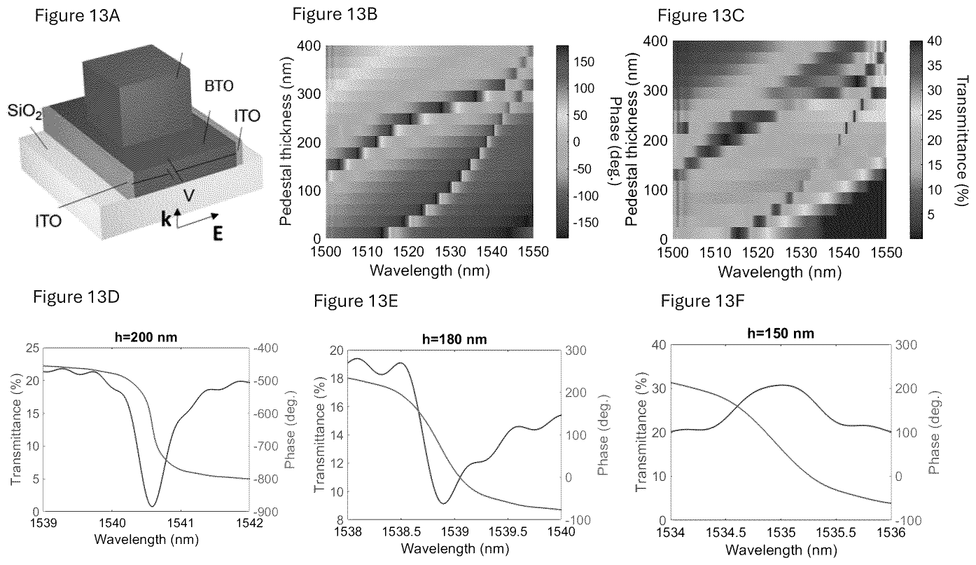

FIGS. 13A through 13F illustrate modifications of metasurface unit cell in accordance with an embodiment. FIG. 13A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of BTO, the electrodes of ITO, and the substrate of silicon oxide. The length of the electro-optic material in the x direction is about 1300 nm and in the y direction is set to be infinite. The periodicity in the x direction is about 1425 nm and in the y direction is about 1500 nm. The high-index resonator has a height of about 820 nm. The ITO electrodes have a width of about 40 nm. FIG. 13B shows the phase at various electro-optic layer thickness (shown as pedestal thickness) and various operating wavelengths. FIG. 13C shows the transmittance at various electro-optic layer thickness (shown as pedestal thickness) and various operating wavelengths. FIG. 13D shows transmittance and phase at various wavelengths when the electro-optic layer thickness is about 200 nm. FIG. 13E shows transmittance and phase at various wavelengths when the electro-optic layer thickness is about 180 nm. FIG. 13F shows transmittance and phase at various wavelengths when the electro-optic layer thickness is about 150 nm. High Q factors are accompanied by a dip. Choosing the optimal thickness of the electro-optic material can achieve an almost flat transmittance.

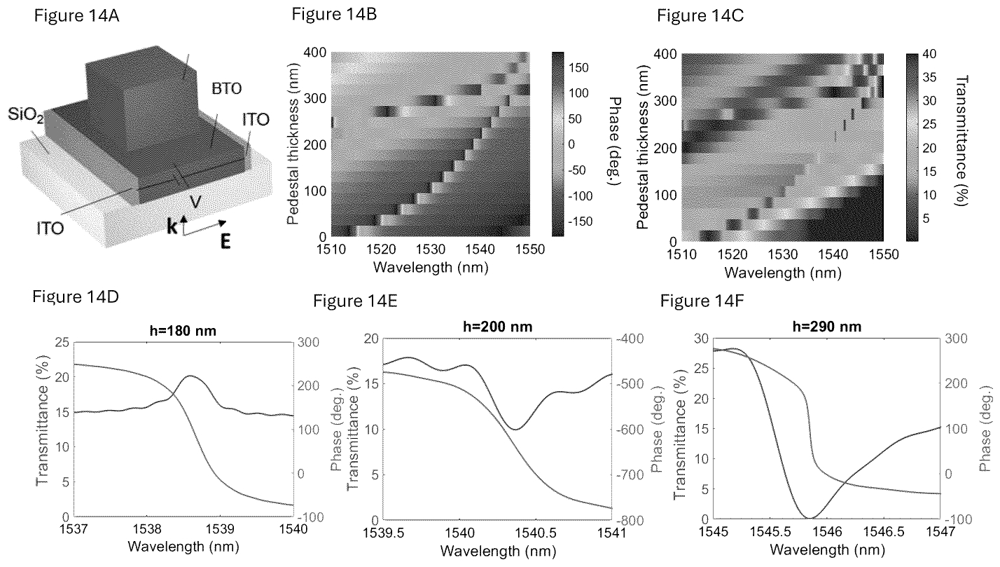

FIGS. 14A through 14F illustrate modifications of metasurface unit cell in accordance with an embodiment. FIG. 14A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of BTO, the electrodes of ITO, and the substrate of silicon oxide. The length of the electro-optic material in the x direction is about 1250 nm and in the y direction is set to be infinite. The periodicity in the x direction is about 1425 nm and in the y direction is about 1500 nm. The high-index resonator has a height of about 820 nm. The ITO electrodes have a width of about 40 nm. FIG. 14B shows the phase at various electro-optic layer thickness (shown as pedestal thickness) and various operating wavelengths. FIG. 14C shows the transmittance at various electro-optic layer thickness (shown as pedestal thickness) and various operating wavelengths. FIG. 14D shows transmittance and phase at various wavelengths when the electro-optic layer thickness is about 180 nm. FIG. 14E shows transmittance and phase at various wavelengths when the electro-optic layer thickness is about 200 nm. FIG. 14F shows transmittance and phase at various wavelengths when the electro-optic layer thickness is about 290 nm. High Q factors are accompanied by a dip. Choosing the optimal thickness of the electro-optic material can achieve an almost flat transmittance.

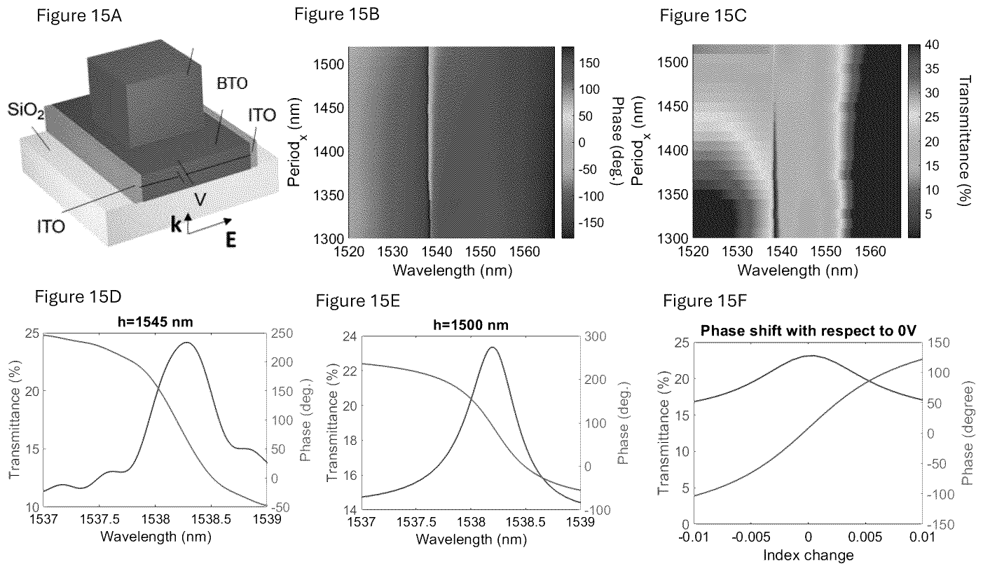

FIGS. 15A through 15F illustrate modifications of metasurface unit cell in accordance with an embodiment. FIG. 15A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of BTO, the electrodes of ITO, and the substrate of silicon oxide. The length of the electro-optic material in the x direction is about 1250 nm and in the y direction is set to be infinite. The periodicity in the y direction is about 1425 nm. The high-index resonator has a height of about 820 nm. The ITO electrodes have a width of about 40 nm. The thickness of the electro-optic material is about 180 nm. FIG. 15B shows the phase at various periodicity in x direction and various operating wavelengths. FIG. 15C shows the transmittance at various periodicity in x direction and various operating wavelengths. FIG. 15D shows transmittance and phase at various wavelengths when the periodicity in x direction is about 1545 nm. FIG. 15E shows transmittance and phase at various wavelengths when the periodicity in x direction is about 1500 nm. FIG. 15F shows phase shift at an operating wavelength of about 1538.3 nm. The phase shift is about 225 degrees.

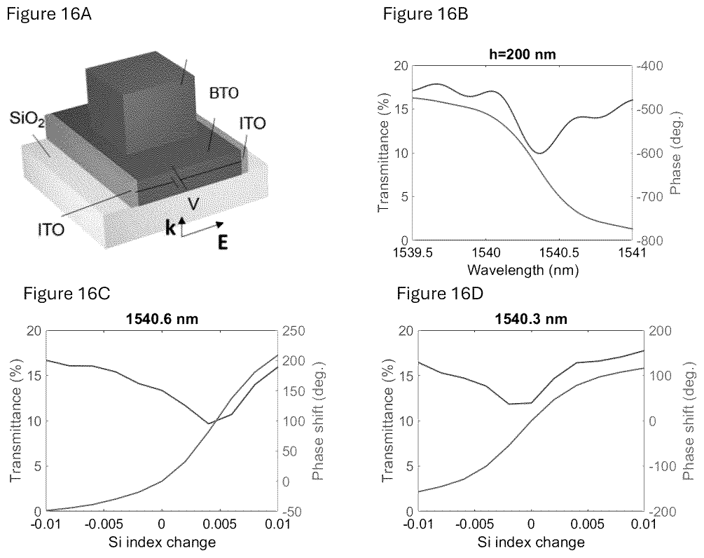

FIGS. 16A through 16D illustrate modifications of metasurface unit cell in accordance with an embodiment. FIG. 16A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of BTO, the electrodes of ITO, and the substrate of silicon oxide. The length of the electro-optic material in the x direction is about 1250 nm and in the y direction is set to be infinite. The periodicity in the y direction is about 1425 nm and in x direction is about 1500 nm. The high-index resonator has a height of about 820 nm. The ITO electrodes have a width of about 40 nm. The thickness of the electro-optic material is about 200 nm. FIG. 16B shows transmittance and phase at various wavelengths. FIG. 16C shows phase shift at an operating wavelength of about 1540.6 nm. The phase shift is about 260 degrees. FIG. 16D shows phase shift at an operating wavelength of about 1540.3 nm. The phase shift is about 270 degrees.

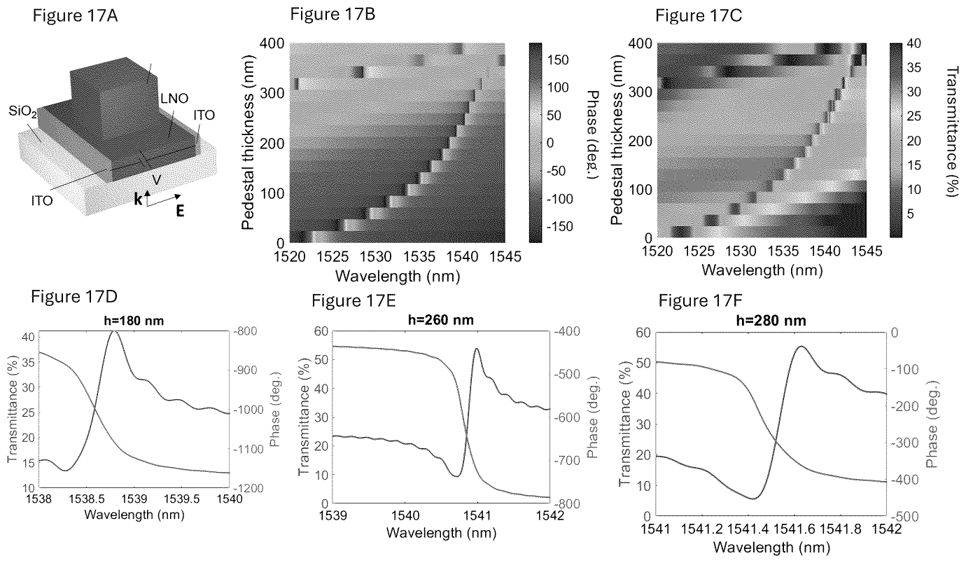

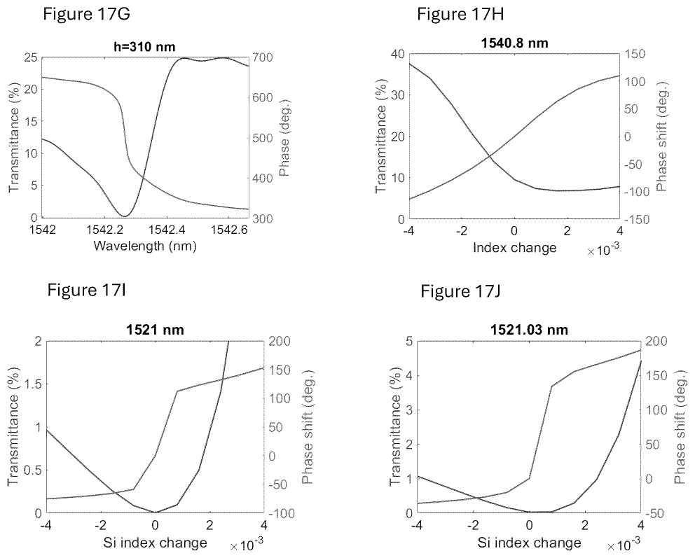

FIGS. 17A through 17J illustrate modifications of metasurface unit cell in accordance with an embodiment. FIG. 17A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of LNO, the electrodes of ITO, and the substrate of silicon oxide. The length of the electro-optic material in the x direction is about 1200 nm and in the y direction is set to be infinite. The periodicity in the x direction is about 1200 nm and in the y direction is about 1500 nm. The high-index resonator has a height of about 820 nm. The ITO electrodes have a width of about 40 nm. FIG. 17B shows the phase at various electro-optic layer thickness (shown as pedestal thickness) and various operating wavelengths. FIG. 17C shows the transmittance at various electro-optic layer thickness (shown as pedestal thickness) and various operating wavelengths. FIG. 17D shows transmittance and phase at various wavelengths when the electro-optic layer thickness is about 180 nm. FIG. 17E shows transmittance and phase at various wavelengths when the electro-optic layer thickness is about 260 nm. FIG. 17F shows transmittance and phase at various wavelengths when the electro-optic layer thickness is about 280 nm. FIG. 17G shows transmittance and phase at various wavelengths when the electro-optic layer thickness is about 310 nm. FIG. 17H shows transmittance and phase at 1540.8 nm wavelength and the electro-optic layer thickness is about 258 nm when the refractive index changes. The phase shift is about 230 degrees. FIG. 17I shows transmittance and phase at 1521 nm wavelength and the electro-optic layer thickness is about 310 nm when the refractive index changes. The phase shift is about 220 degrees. FIG. 17J shows transmittance and phase at 1521.03 nm wavelength and the electro-optic layer thickness is about 310 nm when the refractive index changes. The phase shift is about 220 degrees.

Many embodiments provide metasurfaces of which the phase in transmission spans a broad range from about 0 degrees to about 360 degrees while transmission stays constant. Such embodiments implement an electro-optic material in the metasurface. A number of parameters play an important role in establishing this condition such as (but not limited to) the metasurface period in the x and y-directions, the thickness of the electro-optic material, and the spatial extent of the electro-optic material. need to be chosen appropriately. FIGS. 15A through 15F show how the period in the x direction affects the phase and transmittance spectra.

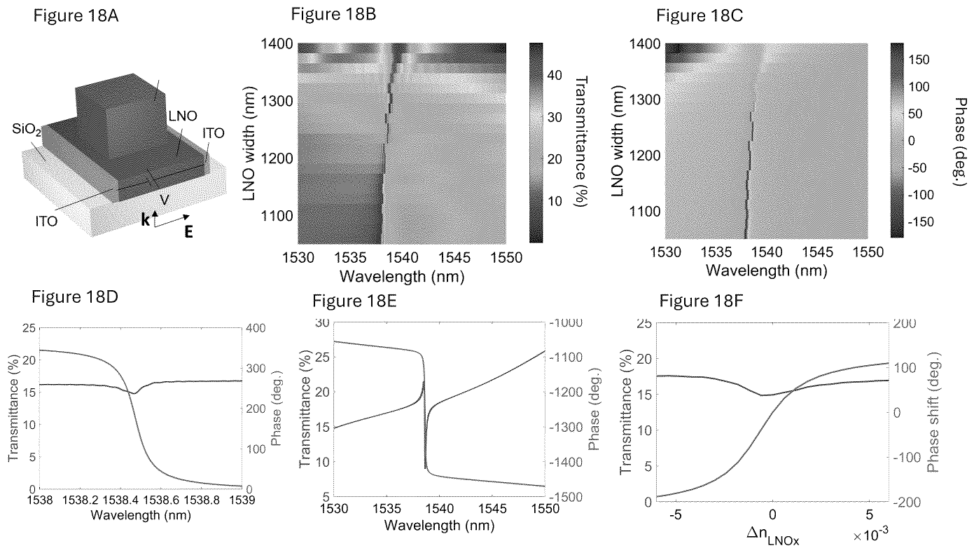

Several embodiments provide that optimal width of the electro-optic material can enable the achievement of an almost constant transmittance while the phase of the transmittance changes from 0 degrees to 360 degrees in the spectral domain. FIGS. 18A through 18F illustrate the effect of the width of the electro-optic material on the phase and transmittance spectra in accordance with an embodiment. FIG. 18A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of LNO, the electrodes of ITO, and the substrate of silicon oxide. The length of the electro-optic material in the y direction is set to be infinite. The periodicity in the x direction is about 1500 nm and in the y direction is about 1440 nm. The high-index resonator has a height of about 830 nm. The ITO electrodes have a width of about 40 nm. The thickness of the electro-optic layer is about 280 nm. FIG. 18B shows the transmittance at various electro-optic layer width and various operating wavelengths. FIG. 18C shows the phase at various electro-optic layer width and various operating wavelengths. Changing LNO width affects the phase and transmission characteristics. FIG. 18D shows transmittance and phase at various wavelengths when the electro-optic layer width is about 1220 nm. The transmittance stays almost constant, which is more desirable. FIG. 18E shows transmittance and phase at various wavelengths when the electro-optic layer width is about 1250 nm. The transmittance has a less desirable behavior. FIG. 18F shows transmittance and phase shift at 1538.45 nm wavelength when the refractive index of LNO changes. The electro-optic layer width is about 1220 nm. Under an applied bias, a phase shift of greater than about 300 degrees can be observed. The metasurface shows an electrically tunable optical response.

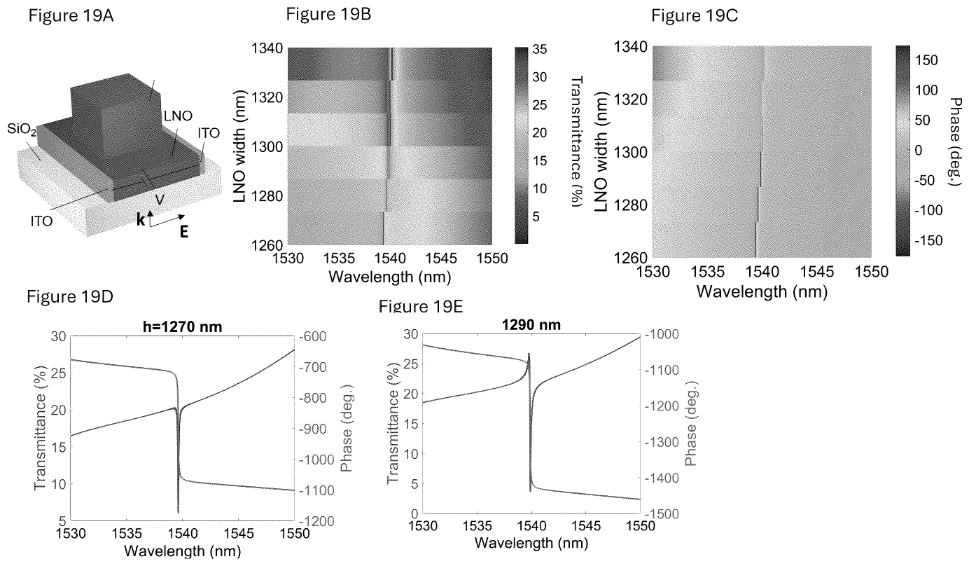

Several embodiments provide that an optimal period in the y-direction (Py) can affect the metasurface behavior. FIGS. 19A through 19E illustrate the effect of Py on the optimal behavior of the metasurface in accordance with an embodiment. FIG. 19A illustrates a unit cell of the metasurface. The unit cell can include a high-index resonator in the shape of a pillar and an electro-optic layer on the substrate. A pair of electrodes are positioned laterally to the electro-optic layer to apply a voltage. The pillar can be made of silicon, the electro-optic layer of LNO, the electrodes of ITO, and the substrate of silicon oxide. The length of the electro-optic material in the y direction is set to be infinite. The periodicity in the x direction is about 1500 nm and in the y direction is about 1420 nm. The high-index resonator has a height of about 830 nm. The ITO electrodes have a width of about 40 nm. The thickness of the electro-optic layer is about 280 nm. FIG. 19B shows the transmittance at various electro-optic layer width and various operating wavelengths. FIG. 19C shows the phase at various electro-optic layer width and various operating wavelengths. FIG. 19D shows transmittance and phase at various wavelengths when the electro-optic layer width is about 1270 nm. FIG. 19E shows transmittance and phase at various wavelengths when the electro-optic layer width is about 1290 nm. When the Py period is shifted from the optimal condition, transmittance characteristics vary. As can be readily appreciated, the optimal condition of a high constant transmittance and varying phase can be observed at multiple values of the geometrical parameters.

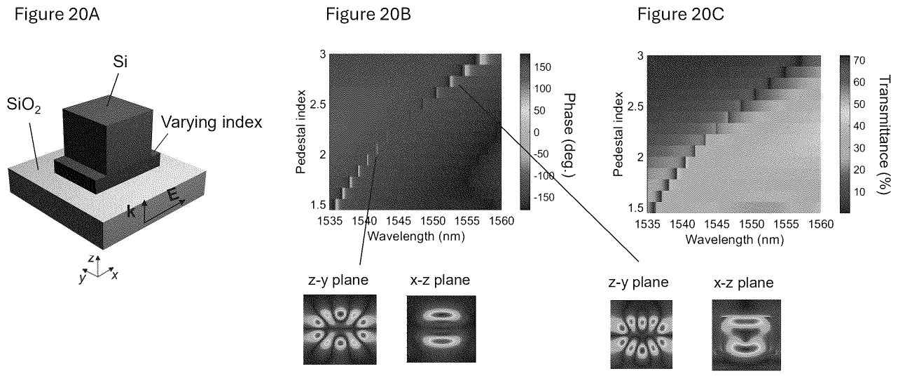

FIGS. 20A through 20C illustrate the effects of changing the refractive index of the electro-optic material in accordance with an embodiment. FIG. 20A illustrates a unit cell of the metasurface. The unit cell can include a high-index resonator in the shape of a pillar and an electro-optic layer on the substrate. The pillar can be made of silicon and the substrate of silicon oxide. FIG. 20B shows the phase at various refractive index of the electro-optic layer and various operating wavelengths. FIG. 20C shows the transmittance at various refractive index of the electro-optic layer and various operating wavelengths.

As can be readily appreciated, the metasurfaces in accordance with many embodiments can operate in the transmission mode or the reflection mode. The metasurfaces operating in the transmission mode can also operate in the reflection mode. Some embodiments may convert the metasurfaces in transmission mode to reflection mode by incorporating a metallic and/or dielectric mirror. The metallic and/or dielectric mirror may not be necessary for operating in the reflection mode. Incorporating the metallic and/or dielectric mirror can boost the optical efficiency of the metasurfaces.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A metasurface comprising:
a plurality of repeating unit cells with a periodicity conformally disposed on a substrate; wherein the periodicity is less than a wavelength in free space of an operating light;
wherein each of the plurality of repeating unit cells comprises:
a resonant structure on a substrate;
an electro-optic layer between the resonant structure and the substrate; and
two electrodes configured to apply a bias across the electro-optic layer;
wherein the bias changes a refractive index of the electro-optic layer to tune an optical response of the metasurface; and
wherein the metasurface controls a phase of the operating light with a quality factor of at least 10.

2. The metasurface of claim 1, wherein the wavelength is selected from the group consisting of: an ultraviolet wavelength from 100 nm to 400 nm, a visible wavelength from 380 nm to 800 nm, a near infrared wavelength from 800 nm to 2500 nm, and an infrared wavelength from 780 nm to 1000 μm.

3. The metasurface of claim 1, wherein the plurality of repeating unit cells is arranged in an array.

4. The metasurface of claim 1, wherein the resonant structure has a shape selected from the group consisting of: a cuboid, a cube, a pillar, a cylinder, an elliptical cylinder, a trapezoid, a triangular prism, a polygonal prism, a pyramid, and a combination thereof.

5. The metasurface of claim 1, wherein the resonant structure has a refractive index greater than the substrate.

6. The metasurface of claim 1, wherein the electro-optic layer has a refractive index less than the substrate.

7. The metasurface of claim 1, wherein the resonant structure comprises a material selected from the group consisting of: gallium arsenide, gallium phosphide, silicon, amorphous silicon, germanium, aluminum arsenide, aluminum gallium arsenide, and molybdenum diselenide.

8. The metasurface of claim 1, wherein the electro-optic layer comprises a material selected from the group consisting of: barium titanate, lithium niobate, JRD1, and polymethyl methacrylate with JRD1.

9. The metasurface of claim 1, wherein the two electrodes are configured to apply a bias across the electro-optic layer laterally or vertically.

10. The metasurface of claim 1, wherein the two electrodes comprise a material selected from the group consisting of: a metal, a doped semiconductor, and graphene.

11. The metasurface of claim 1, wherein the two electrodes comprise a material selected from the group consisting of: gold, silver, copper, aluminum, indium tin oxide, cadmium oxide, aluminum doped zinc oxide, gallium doped zinc oxide, doped gallium arsenide, doped indium arsenide, and doped molybdenum diselenide.

12. The metasurface of claim 1, wherein the electro-optic layer has a shape that overlaps with the resonant structure of each of the repeating unit cells.

13. The metasurface of claim 1, wherein the electro-optic layer has a shape that overlaps with a row of resonant structures.

14. The metasurface of claim 1, further comprises a dielectric layer between the resonant structure and the electro-optic layer to avoid electrostatic breakdown.

15. The metasurface of claim 1, further comprises a back reflector on an opposite side of the substrate from the resonant structure.

16. The metasurface of claim 15, wherein the back reflector comprises a material selected from the group consisting of: gold, silver, aluminum, copper, a distributed Bragg reflector, and a metasurface mirror.

17. The metasurface of claim 1, wherein a transmittance of the metasurface is greater than 10%.

18. The metasurface of claim 1, wherein a phase shift of the metasurface is from 0 degree to 360 degrees.

19. The metasurface of claim 1, wherein the electro-optic layer comprises lithium niobate, has a thickness between 180 nm and 300 nm, and has a width between 1150 nm and 1400 nm; wherein a period of the plurality of the unit cells in x-direction is 1500 nm and in y-direction is 1440 nm.

20. The metasurface of claim 1, wherein the metasurface is configured to be a portion of: a wavefront shaping system, a dynamic beam steering system or a chip scale laser.
